(19) United States
(12) Patent Application Publication
(10) Pub. No.: US 2007/0148314 A1
(43) Pub. Date: Jun. 28, 2007

(54) PEANUT BUTTER HAVING A NON-HYDROGENATED VEGETABLE OIL BASED HIGH DIGLYCERIDE EMULSIFIER

(76) Inventors: Lawrence Skogerson, Mission Hills, MS (US); Troy Boutte, Overland Park, KS (US); Jennifer Dehn, Smithville, MO (US); Ronald Zelch, Overland Park, KS (US)

Correspondence Address: HOVEY WILLIAMS LLP, 2405 GRAND BLVD., SUITE 400, KANSAS CITY, MO, 64108, US

(21) Appl. No.: 11/279,733

(22) Filed: Apr. 13, 2006

Related U.S. Application Data
(60) Provisional application No. 60/754,269, filed on Dec. 28, 2005.

(51) Int. Cl. A23D 7/00

(52) U.S. Cl. 426/602

(57) ABSTRACT

A mono-, di-, and triglyceride stabilizer is provided that is especially adapted for stabilizing nut butters such as peanut butter to prevent separation of the oil portion of the butter from the solids portion while retaining the glossy appearance of the product. The stabilizer is obtained by interesterification or glycerolysis of triglycerides with glycerol. The diglyceride portion w/w of the stabilizer is greater than 60%, and most preferably about 65%. Preferably about 1% to about 4% w/w of the stabilizer is added to the nut butter.

### RELATED APPLICATION

The present non-provisional patent application claims, with regard to all common subject matter, priority benefit of a provisional patent application titled ELEVATED DIGLYCERIDE EMULSIFIER COMPOSITION, SHORTENING, PUFF PASTRY MARGARINE AND PEANUT BUTTER CONTAINING THE EMULSIFIER COMPOSITION; U.S. patent application No. 60/754,269; filed Dec. 28, 2005. The identified provisional patent application is hereby incorporated by reference into the present non-provisional patent application.

### BACKGROUND OF THE INVENTION

1. Field of the Invention

This invention relates to a glyceride emulsifier having an elevated diglyceride fraction that is especially useful in stabilizing nut butters such as peanut butter or the like. The high diglyceride emulsifier is obtained by the interesterification or glycerolysis of triglycerides with glycerol. Triglyceride reacts with glycerol at high temperatures, for example 200-250° C. under alkaline catalysis, yielding a mixture of mono-, di-, and triglycerides, and a small portion of unreacted glycerol. Commercial mono- and diglycerides usually contain 40-55% monoglycerides, 38-45% diglycerides, 8-12% triglycerides, and 1-7% free glycerol. In accordance with this invention, the diglyceride portion w/w is increased to greater than 60% to about 80%, and most preferably from about 65%, as, for example, by vacuum distillation, with the remaining monoglyceride portion being about 10% and the triglyceride portion of the order of 15%. Alternatively, the glycerine to fat ratio is selected to yield the required elevated diglyceride portion.

The high diglyceride emulsifier (herein “HiDi”), is particularly useful as a stabilizer to prevent separation of oil from the solids of nut butter spreads, such as peanut butter, during use of the product and during storage. The HiDi emulsifier has been found to provide required stabilization of peanut oil in peanut butters, for example, similar to the stability heretofore obtained using saturated fats or partially hydrogenated fats.

2. Description of the Prior Art

Peanut butter consists of roasted comminuted (for example, ground) peanuts normally with not more than ten percent of optional functional ingredients added. As used herein, the term “butter” is defined as a substantially self-sustaining semi-solid mass or paste made from comminuted oil-bearing seeds, used for food, and most commonly provided commercially as an emulsified product. “Butters” other than peanut butter may be made from nuts or nut-like oil-bearing seeds. Examples include sunflower seeds, soybeans, almonds, walnuts, pecans, and hazelnuts. The most important characteristics of these products, including peanut butter, are flavor and texture. During the grinding process, oil is released and, in the absence of stabilizers, the oil and the solids will separate into an oily layer above a relatively dry mixture of peanut solids and a little oil. Peanut butter with no stabilizer added is usually labeled as a “natural” product. However, unstabilized peanut butter requires refrigeration or mixing before use. Although natural peanut butters are flavorful, their use is inconvenient, and separation of the oil typically renders such products unsuitable for many applications.

Typical commercial peanut butter normally includes salt, natural sweeteners, emulsifiers, and stabilizers. Salt and sweeteners are added for flavor. Emulsifiers and stabilizers are added to prevent separation of the oil from the solids of the product and to achieve the texture desired by the manufacturer. One important textural characteristic is smoothness. A poorly emulsified or stabilized peanut butter will have a granular mouth feel rather than a smooth and creamy mouth feel. A second important characteristic is spreadability. Peanut butter that is too firm cannot be easily spread on a slice of bread without tearing of the slice. Smoothness and firmness are highly dependent on the stabilizer. Furthermore, fats suitable for peanut butter stabilizers are relatively expensive and are sometimes not readily available.

Fully hydrogenated peanut oil was one of the first stabilizers developed for peanut butter. FDA Standards of Identity now permit the use of any vegetable oil hardfat as a stabilizer. Monoglycerides prepared from any fully hardened vegetable oil source are also permitted for the same function.

Crystal structure of the stabilizer is important. Beta-crystalline hardfat, such as that made from peanut oil, solidifies in an unstable form when initially chilled in peanut butter. As the fat solids become courser and, therefore, more stable crystals are formed, the surface of the peanut butter becomes dull and loses its slick shiny appearance. The peanut butter then becomes less stable and free oil tends to separate. Efforts to overcome this oil separation problem by adding additional stabilizer have not been successful because the peanut butter becomes an undesirable firmer and drier product.

Beta-prime hardfats and monoglycerides solidify into a permanently fine-grained crystal, giving the peanut butter a desirable glossy surface and stability under a wide range of storage conditions. Cottonseed, soybean, palm, and rapeseed oil hardfats, distilled monoglycerides prepared from these triglycerides, and blends of hardfat and monoglycerides have been used to avoid separation of oil from the solids of the peanut butter, with nutrition studies only recently demonstrating that saturated fats and partially hydrogenated oil fats that include trans fats can have adverse cardiological effects.

Accordingly, there is an unfulfilled need for a peanut butter emulsifier and stabilizer that prevents separation of oil from the solids of peanut butter, and other like nut butters, during storage of the product under varying environmental temperature conditions, and that does not result in introduction of trans fats into the peanut butter as occurs from the use of partially hydrogenated oil fat emulsifiers.

### SUMMARY OF THE INVENTION

It has now been found that a trans free emulsifier having an elevated diglyceride content is useful in stabilizing nut butters to prevent separation of oil from the solids of the product while desirable surface sheen and glossiness are retained. The emulsifiers that produce this effect are mono- and diglycerides produced from fully saturated fat sources and that have a higher than normal content of diglycerides. These HiDi emulsifiers function as well as standard stabilizers prepared from partially hydrogenated cotton seed or soybean oil. Because the HiDi emulsifiers are especially effective in structuring a vegetable oil such as peanut oil by increasing the viscosity of the oil at a relatively low emulsifier concentration, the desired oil separation resistance characteristics of the resulting peanut butter product are achieved without the inclusion of excessive saturated fat or partially hydrogenated fat containing trans fatty acids.

### DETAILED DESCRIPTION OF PREFERRED EMBODIMENTS

The mono- and diglycerides that constitute this invention are preferably produced by interesterification of C₁₂-C₂₂ and preferably C₁₆-C₁₈ fat in the presence of glycerin and a catalyst such as calcium or sodium hydroxide. After the interesterification reaction, the catalyst is inactivated by addition of phosphoric acid and the excess glycerin is removed by distillation under vacuum. The interesterification reaction may also be carried out in the presence of an appropriate enzyme as the catalyst. The glycerin to fat ratio is selected to give a mono- and diglyceride composition w/w that falls within the parameters of Table I below.

TABLE I

Fatty acids C₁₂-C₂₂, preferably >80% C₁₆-C₁₈
Monoglycerides <30%; preferably <20%; most preferably
about 10% or less
Diglycerides >60%; preferably about 65%
Triglycerides being the remainder

Alternately, the selected fat may be interesterified in the presence of glycerin and a catalyst such as calcium or sodium hydroxide. After the interesterification reaction the catalyst is inactivated by addition of phosphoric acid and the excess glycerin is removed by an appropriate procedure such as distillation under vacuum. As a further alternative, a selected fatty acid may be esterified in the presence of glycerin and a catalyst such as calcium or sodium hydroxide. After the esterification reaction the catalyst is inactivated by addition of phosphoric acid and the excess glycerin is removed by an appropriate procedure such as distillation under vacuum. The interesterification or esterification reaction may also be carried out in the presence of an appropriate enzyme as the catalyst. The glycerin to fat ratio is picked to give a maximal level of monoglycerides. The resulting mono and diglyceride portion is subjected to distillation under vacuum to separate most of the monoglyceride component from the diglyceride component, to again provide a composition that is within the parameters of Table I.

### EXAMPLE 1

Fully hydrogenated soybean oil was interesterified with excess glycerin (ratio of three moles of glycerin to one mole of fat) in the presence of calcium hydroxide as the interesterification catalyst. After the reaction was completed phosphoric acid was added to inactivate the catalyst and the excess glycerin was removed by distillation under vacuum. The resulting mono- and diglyceride was subjected to distillation in a short path still to remove monoglycerides. The residual portion consisted of a new mono- and diglyceride portion (Sample 1) having the following composition, w/w:

TABLE II

| | |
|---|---|
| Monoglyceride | 13.7% |
| Diglyceride | 64.5% |
| Triglyceride | 21.8% |
| Iodine Value | 1.55 |

In lieu of soybean oil, other vegetable oils may be used for the preparation of the high diglyceride emulsifier, including, but not limited to, canola oil, coconut oil, corn oil, cottonseed oil, flaxseed oil, palm oil, palm kernel oil, peanut oil, safflower oil, sesame oil, and sunflower oil.

### EXAMPLE 2

A commercially available natural creamy peanut butter selected for testing was found to contain approximately 1% salt w/w. An additional 1% w/w salt was added to the peanut butter product along with 6.9% w/w dextrose. Accordingly, the peanut butter tested was within the standard of identity for peanut butter production in accordance with FDA regulations.

Procedure

The appropriate amount of peanut butter was placed in a steam kettle and heated to a temperature of 71-74° C. During the heating stage 204 g dextrose 29.6 g of salt was added with stirring. When the temperature reached 71-74° C. the melted stabilizer was added with vigorous stirring. The amount of the stabilizers w/w added were:
None for control
1.5% commercial stabilizer prepared from hydrogenated cotton seed oil
2% Emulsifier Blend 1 (HiDi-Table II)
2% Emulsifier Blend 2 (non-distilled mono- and diglycerides)

Analysis of these stabilizers yielded:

| | Monoglyceride | Diglyceride | Triglyceride |
|---|---|---|---|
| Cotton seed stabilizer | 0% | 0% | 100% |
| Emulsifier Blend 1 | 13.7% | 64.5% | 21.8% |
| (HiDi Table II) | | | |
| Emulsifier Blend 2 | 26.6% | 53.4% | 20.0% |

Stirring was continued for five minutes to assure complete incorporation of the stabilizer. The kettle was then cooled to a temperature of 36-40° C. Samples were prepared for future evaluation by adding 225 grams of peanut butter into each of eight heated jars. Jars were then placed on a flat surface at room temperature for cooling.

From about 1% to about 4% of the stabilizer has been found to provide stabilization of nut butters when blended with the butter, preventing separation of oil from the solids while maintaining a glossy appearance of the blended product.

### EXAMPLE 3

The samples of Example 2 were subjected to analysis for firmness and stickiness using a texture analyzer (TA-XT2 from Texture Technologies) employing a cone-shaped probe. Firmness is the force required to press the probe into an undisturbed sample. Stickiness is the force required to withdraw the probe from the sample and is given as a negative value. Results showed that Emulsifier blend 1 was very similar to the commercial stabilizer with respect to firmness and stickiness. A peanut butter that has not been stabilized is not firm. A too firm peanut butter will be difficult to spread. A peanut butter that is too sticky will not have the smooth cream texture expected by many consumers.

| | Firmness | Stickiness |
|---|---|---|
| No addition | 20 | −117 |
| Commercial stabilizer | 257 | −457 |
| Emulsifier blend 1 | 259 | −514 |
| Emulsifier blend 2 | 698 | −647 |

### EXAMPLE 4

Viscosity was measured with a Brookfield viscometer (HAT Dial model) connected to a Helipath attachment. The Helipath forces the spindle into the sample in a spiral fashion such that the spindle is always in contact with undisturbed sample. Results again showed that only Emulsifier blend 1, as contrasted with Emulsifier blend 2, gave results similar to those obtained with the commercial stabilizer.

| | Viscosity (centipoises) |
|---|---|
| No addition | 260,000 |
| Commercial stabilizer | 1,611,400 |
| Emulsifier blend 1 | 1,896,600 |
| Emulsifier blend 2 | 16,825,000 |

### EXAMPLE 5

Surface glossiness is often related to smoothness of peanut butter. Ideally the surface should be glossy without separation of oil. Emulsifier blend 1 gave a more glossy surface than that of the commercial stabilizer even though no oil separation had occurred.

| | Glossiness | Oil Separation |
|---|---|---|
| No addition | 5 | 10.3% of height |
| Commercial stabilizer | 3 | None |
| Emulsifier blend 1 | 5 | None |
| Emulsifier blend 2 | 1 | None |

Similar results can be obtained when the emulsifier as described herein is used with butters for food usage made from sunflower seeds, soybeans, almonds, walnuts, pecans, and hazelnuts, and mixtures thereof.

We claim:

1. A stabilizer for preventing separation of oil from the solids content of nut butter products while retaining the glossiness of the product comprising a mixture of mono-, di-, and triglycerides, the diglyceride portion of the composition being greater than 60% w/w, from about 1% to about 4% of the stabilizer being capable of stabilizing the nut butter.

2. A stabilizer as set forth in claim 1, wherein the diglyceride portion of the composition being about 65% w/w.

3. A stabilizer as set forth in claim 1, wherein the emulsifier is prepared by interesterification of C₁₂-C₂₂ fatty acid and glycerol.

4. A stabilizer as set forth in claim 3, wherein the emulsifier is prepared by interesterification of C₁₆-C₁₈ fatty acid and glycerol.

5. A stabilizer as set forth in claim 3, wherein said fatty acid is soybean oil.

6. A stabilizer as set forth in claim 3, wherein said fatty acid is selected from the group consisting of canola oil, coconut oil, corn oil, cottonseed oil, flaxseed oil, palm oil, palm kernel oil, peanut oil, safflower oil, sesame oil, soybean oil, and sunflower oil.

7. A method of preparing a stabilizer for preventing separation of oil from the solids content of nut butter products while retaining the glossiness of the product comprising the steps of carrying out interesterification of C₁₂-C₂₂ fat and glycerine in the presence of a catalyst, inactivating the catalyst, and removing excess glycerin, the glycerin to fat ratio being selected to give a mono- and diglyceride composition wherein the diglyceride portion is greater than 60% w/w, from about 1% to about 4% of the stabilizer being capable of stabilizing the nut butter.

8. A method of preparing a stabilizer as set forth in claim 7, wherein the glycerin to fat ratio being selected to give a mono- and diglyceride composition wherein the diglyceride portion is at least about 70-80% w/w.

9. A method of preparing a stabilizer for preventing separation of oil from the solids content of nut butter products while retaining the glossiness of the product comprising the steps of carrying out interesterification of C₁₂-C₂₂ fat and glycerine in the presence of a catalyst, inactivating the catalyst, removing excess glycerin, and removing sufficient monoglyceride from the reaction product by vacuum distillation to increase the diglyceride portion to from greater than 60% to about 80% w/w, from about 1% to about 4% of the stabilizer being capable of stabilizing the nut butter.

10. A method of preparing a stabilizer as set forth in claim 9, wherein is included the step of removing sufficient monoglyceride from the reaction product by vacuum distillation to increase the diglyceride portion to at least about 70-80% w/w.

11. A method of preparing a stabilizer as set forth in claim 9, wherein is included the step of removing sufficient monoglyceride from the reaction product by vacuum distillation to increase the diglyceride portion to about 65% w/w.

12. A stabilizer for preventing separation of oil from the solids content of nut butter products while retaining the glossiness of the product comprising a mixture of about 14% monoglyceride, about 64.5% diglyceride, and about 22% triglycerides w/w, from about 1% to about 4% of the stabilizer being capable of stabilizing the nut butter.

13. A stabilized peanut butter comprising about 2% w/w of an stabilizer blended with the peanut butter comprising a mixture of mono-, di-, and triglycerides, the diglyceride portion of the composition being greater than 60% w/w.

14. A stabilized peanut butter comprising about 2% w/w of an stabilizer blended with the peanut butter comprising a mixture of mono-, di-, and triglycerides, the diglyceride portion of the composition is about 65% w/w.

15. A stabilized peanut butter as set forth in claim 13, wherein the stabilizer mixture includes about 14% monoglyceride, about 64.5% diglyceride, and about 22% triglycerides w/w.

16. A butter made from comminuted oil-bearing seeds comprising an effective amount of the elevated diglyceride stabilizer of claim 1.

17. A butter as set forth in claim 1, wherein the oil-bearing seeds are selected from the group consisting of peanuts, sunflower seeds, soybeans, almonds, walnuts, pecans, hazelnuts, and mixtures thereof.

18. A butter as set forth in claim 14, wherein the oil portion of the butter does not separate from the solids portion and the butter has a glossiness value greater than that obtained by addition of a conventional stabilizer.

19. A butter as set forth in claim 18, wherein the oil portion of the butter does not separate from the solids portion and the butter has a glossiness value at least about equal to a butter without the addition of a stabilizer.

20. A butter as set forth in claim 18, wherein the butter has a glossiness value of about 5.
